(19) United States
(12) Patent Application Publication
(10) Pub. No.: US 2021/0021762 A1
(43) Pub. Date: Jan. 21, 2021

(54) OPTICAL TRANSMISSION SYSTEM

(71) Applicant: Nihon Video System Co., Ltd., Tsushima-shi (JP)

(72) Inventors: Kentaro Hashiguchi, Tsushima-shi (JP); Akikazu Hashiguchi, Tsushima-shi (JP); Ken Tsuchiya, Tsushima-shi (JP); Hidetake Sugita, Tsushima-shi (JP)

(73) Assignee: Nihon Video System Co., Ltd., Tsushima-shi (JP)

(21) Appl. No.: 16/930,099

(22) Filed: Jul. 15, 2020

(30) Foreign Application Priority Data
Jul. 19, 2019 (JP) 2019-134049

(51) Int. Cl. H04N 5/232; H04N 5/262

(52) U.S. Cl. CPC H04N 5/23296; H04N 5/2628

(57) ABSTRACT

The present invention provides an optical transmission system for optical transmission of a signal between a first and a second adaptors, wherein the first and the second adaptors each include an input terminal, a determination unit, and a display unit, a first signal is input to the input terminal, the first signal being an analog video signal or a digital video signal, the determination unit is configured to determine whether the first signal is the analog video signal or the digital video signal and to determine a type of the digital video signal when the first signal is the digital video signal, and the display unit is configured to display information obtained in determination by the determination unit.

### TECHNICAL FIELD

The present invention relates to an optical transmission system configured to optically transmit an analog video signal or a digital video signal between a pair of adaptors.

### BACKGROUND ART

A video signal of an image captured by a video camera is sent to a video switcher or the like via a transmission cable. When these devices are remotely installed, it is difficult to transmit an electric signal without attenuation. For this reason, long-distance transmission is performed by converting the electric signal into an optical signal on a video camera side, transmitting this optical signal through an optical transmission cable, and then converting the optical signal into the electric signal on a remote device side (Patent Literatures 1 and 2).

### CITATION LIST

### Patent Literature

Patent Literature 1: JP-A-2006-191161

Patent Literature 2: JP-A-2017-092917

Patent Literature 3: JP-A-2016-082468

### SUMMARY OF INVENTION

### Technical Problem

In recent years, the diversification of video filming has led to the diversification of camera types. The specifications of cameras have been diversified, and a camera system has become various, such as 4K/8K, as well as HD filming. A filming style has been also changed dramatically. Consequently, in a filming location, a system including cameras of different models is sometimes used, or a camera that is not a system camera may be used like a system camera, instead of a camera system using multiple cameras of the same model in a one-to-one relationship, such as a dedicated studio camera system. Here, a digital video signal is a signal conforming to a standard for digital video signal transmission and may include an SD-SDI signal, an HD-SDI signal, a 3G-SDI signal, a 6G-SDI signal, and a 12G-SDI signal.

An adaptor of an optical transmission system is provided with an input terminal for analog video signals and an input terminal for digital video signals in order to optically transmit both analog and digital video signals. When the analog video signal is output from a device, a video signal cable is connected to the input terminal for analog video signals. When the digital video signal is output from the device, the video signal cable is connected to the input terminal for analog video signals. Consequently, both analog and digital video signals can be optically transmitted. Further, it is possible to optically transmit analog and digital signals through one input terminal without switching (Patent Literature 3).

The use of such an optical transmission system is very convenient because long-distance wiring of the video signal can be performed regardless of the type of video signals. On the other hand, it is difficult to immediately know which type of video signals is flowing in the video signal cable, which is sometimes inconvenient. The present invention has been made in view of such circumstances and is intended to provide an optical transmission system facilitating the installation of the video signal cable and capable of immediately determining which type of video signals is flowing in the video signal cable.

### Solution to Problem

According to the present invention, provided is an optical transmission system for optical transmission of a signal between a first and a second adaptors, wherein the first and the second adaptors each comprise an input terminal, a determination unit, and a display unit; a first signal is input to the input terminal, the first signal being an analog video signal or a digital video signal; the determination unit is configured to determine whether the first signal is the analog video signal or the digital video signal and to determine a type of the digital video signal when the first signal is the digital video signal; and the display unit is configured to display information obtained in determination by the determination unit.

### Advantageous Effects of Invention

In the optical transmission system of the present invention, the video signal cable can be connected to the same input terminal regardless of the type of signal flowing in the video signal cable, and thus the installation of the video signal cable is facilitated. Further, the system is configured to determine whether the signal input to the input terminal is an analog video signal or a digital video signal, to determine the type of the digital video signal when the first signal is the digital video signal, and to display the information obtained in determination on the display unit. Consequently, it is possible to immediately know which type of video signal is flowing in the video signal cable.

Hereinafter, various embodiments of the present invention are exemplified. The embodiments described below can be combined with each other.

Preferably, the first signal is input to the input terminal of the first adaptor, and the information is displayed on the display unit of the second adaptor.

Preferably, the first and the second adaptors each comprise an output connector for displaying contents of the information on an external monitor.

Preferably, the optical transmission system further comprises a plurality of adaptor groups, wherein each of the adaptor groups comprises the first and the second adaptors; the adaptor groups are connected to each other by a link cable; and the system is configured to collectively display the information obtained in each of the adaptor groups on an external monitor or the display unit.

Preferably, the optical transmission system further comprises a function of displaying contents of the information by means of a dedicated application installed on a mobile phone.

Preferably, the first signal is input to the input terminal of the first adaptor, and the second adaptor is configured to convert the first signal into a different video signal and to output the different video signal.

Preferably, the first signal is input to the input terminal of the first adaptor, and the second adaptor is configured to output the first signal as it is.

Preferably, the first adaptor or the second adaptor comprises a lens-control-signal output terminal and is configured to directly drive at least one of iris, focus, and zoom of a lens of a professional-use video camera connected to the lens-control-signal output terminal.

Preferably, the optical transmission system further comprises a control panel configured to control all or any of iris, focus, and zoom of a lens connected to the first adaptor or the second adaptor.

Preferably, the optical transmission system further comprises an LED and a function of displaying a connection status by turning on the LED provided on at least one of the first adaptor and the second adaptor, wherein the LED is configured to indicate the connection status as long as the first adaptor and the second adaptor are connected in a state where the first adaptor is connected to a driving power source and is also connected to the second adaptor by an optical composite cable, even if a main power source switch of the first adaptor and a main power source switch of the second adaptor are not turned on.

Preferably, the first adaptor and the second adaptor each comprise a LAN connector, and the LAN connector is configured to supply power to a POE device connected to the LAN connector.

Preferably, the system is configured to select either video signal input to the first adaptor or the second adaptor and to display the video signal on an external monitor or the display unit.

Preferably, the first and the second adaptors each comprise a function of connecting an intercom, and the first adaptor comprises a function of supplying power to the intercom connected to the second adaptor. Preferably, the system is configured to transmit a call signal generated by pressing a call button of the intercom connected to the first adaptor, to the intercom connected to the second adaptor.

Preferably, the second adaptor comprises a V mount configured to directly connect the second adaptor to a camera, and the V mount comprises a power source for driving the camera and a cooling fan inside.

### BRIEF DESCRIPTION OF DRAWINGS

FIG. 1 is a block diagram showing an optical transmission system of a first embodiment of the present invention.

FIG. 2 is a block diagram showing an optical transmission system of a second embodiment of the present invention.

FIG. 3 is a detailed block diagram of an adaptor group Aa in FIG. 2.

FIG. 4 is a block diagram showing an optical transmission system of a third embodiment of the present invention.

FIG. 5 is a block diagram showing an optical transmission system of a fourth embodiment of the present invention.

FIG. 6 is a block diagram showing an optical transmission system of a fifth embodiment of the present invention.

### DESCRIPTION OF EMBODIMENTS

Hereinafter, embodiments of the present invention will be described with reference to the drawings.

### 1. First Embodiment

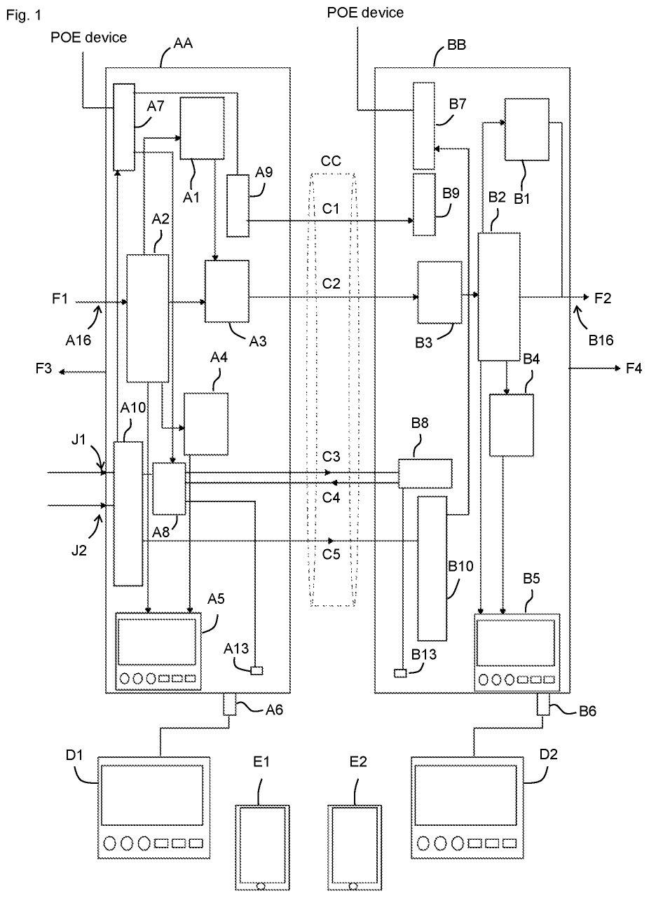

FIG. 1 shows an optical transmission system of the first embodiment of the present invention. The optical transmission system of the first embodiment of the present invention is described below with reference to FIG. 1. The optical transmission system of the present embodiment is configured to perform optical transmission of an analog video signal or a digital video signal between a first adaptor AA and a second the adaptor BB. In one example, the first adaptor AA is a base station remote from a video camera, and the second adaptor BB is a camera adaptor connected to the video camera by wire. Devices, such as a relay mobile and a video switcher, are connected to the base station.

Although FIG. 1 shows, for convenience, a state in which the video signal is transmitted in one direction from the first adaptor AA to the second adaptor BB, the video signal of the camera can be transmitted from the second adaptor (camera adaptor) BB to the first adaptor (base station) AA with the same configuration.

Each component is described below.

The first adaptor AA comprises a modulator A1, a signal determination unit A2, an EO conversion unit A3, a digital signal determination unit A4, a display unit A5, an output connector A6, a LAN connector A7, a communication board A8, an EO conversion unit A9, a power source A10, an LED A13, and an input terminal A16. The power source A10 comprises an AC input terminal J1 for AC input and a DC input terminal J2 for DC input. A video signal cable is connected to the input terminal A16. The signal determination units A2, A4 may be integrated.

The second adaptor BB comprises a demodulator B1, a signal determination unit B2, an OE conversion unit B3, a digital signal determination unit B4, a display unit B5, an output connector B6, a LAN connector B7, a communication board B8, an OE conversion unit B9, a power source B10, an LED B13, and an output terminal B16. A video signal cable is connected to the output terminal B16. The signal determination units B2, B4 may be integrated.

The first and second adaptors AA, BB are connected to each other via an optical transmission composite cable CC. The cable CC comprises cables C1 to C5. The cable C1 connects the EO conversion unit A9 and the OE conversion unit B9. The cable C2 connects the EO conversion unit A3 and the OE conversion unit B3. The cables C1, C2 are optical transmission cables. The cable C3 is a cable for communication from the communication board A8 to the communication board B8. The cable C4 is a cable for communication from the communication board B8 to the communication board A8. The cable C5 is a power transmission cable from the power source A10 to the power source B10.

The signal determination unit A2 is configured to determine the type of a first signal F1 input from the input terminal A16. The first signal F1 is a digital video signal or an analog video signal. That is, the digital video signal and the analog video signal can be input from the same input terminal A16. The signal determination unit A2 determines whether the first signal F1 is a digital video signal or an analog video signal. In this regard, the first signal F1 may be a digital video signal, an analog video signal, or a time code signal. In such a case, the signal determination unit A2 determines whether the first signal F1 is a digital video signal, an analog video signal, or a time code signal.

The digital signal determination unit A4 is configured to determine the type of digital video signal. The digital video signal is a signal conforming to a standard for digital video signal transmission, and the digital video signal may include various types, such as SD-SDI signal, HD-SDI signal, 3G-SDI signal, 6G-SDI signal, and 12G-SDI signal. When the first signal F1 is a digital video signal, the digital signal determination unit A4 determines the type of the digital video signal.

In this way, the signal determination unit A2 determines the type of the first signal F1, so that a cable for analog video signals and a cable for digital video signals can be connected to the same input terminal A16. Information obtained by the signal determination units A2, A4 is displayed on the display unit A5. Further, the information obtained by the signal determination unit A2, A4 is input from the output connector A6 provided in the adaptor AA and also displayed on an external monitor D1. Further, the information obtained by the signal determination units A2, A4 can be displayed on a mobile phone E1 through a dedicated application installed on the mobile phone E1.

When the first signal F1 is determined to be an analog video signal, it is modulated by the modulator Al and sent to the EO conversion unit A3. When the first signal F1 is determined to be a digital video signal, the first signal F1 is sent to the EO conversion unit A3 as it is or after being subjected to predetermined encoding. The first signal F1 is converted from an electric signal into an optical signal in the EO conversion unit A3 and is sent to the OE conversion unit B3 via the cable C2. The optical signal is then converted into an electric signal in the OE conversion unit B3 and is input to the signal determination unit B2. The signal determination unit B2 and the digital signal determination unit B4 have functions similar to the signal determination unit A2 and the digital signal determination unit A4, and the same information as in the determination by the signal determination units A2, A4 can be obtained in the determination by the signal determination units B2, B4. This information is displayed on the display unit B5. Further, the information obtained by the signal determination units B2, B4 is output from the output connector B6 provided in the adaptor BB and is also displayed on an external monitor D2. Further, the information obtained by the signal determination units B2, B4 can be displayed on the mobile phone E2 through the dedicated application installed on a mobile phone E2. Such a configuration enables the information of the first signal F1 input to the first adaptor AA to be displayed on the display unit B5 and the like of the other side (the second adaptor BB), which is convenient. In this regard, the information displayed on the display unit B5 may be the information obtained by the signal determination units B2, B4, or may be the information that is obtained by the signal determination units A2, A4 and is transmitted to the display unit B5 via a cable.

When the signal input to the signal determination unit B2 is determined to be an analog video signal, the signal is demodulated by the demodulator B1 and then output as a second signal F2 from the output terminal B16. When the signal input to the signal determination unit B2 is determined as a digital video signal, the signal is output as the second signal F2 from the output terminal B16 as it is or after being subjected to predetermined encoding.

The first signal F1 is output as a third signal F3 from the first adaptor as it is or after being converted into a different signal and is transmitted to the second adaptor BB through the cable CC to be output as a fourth signal F4.

Further, the system is provided with a function of displaying a connection status by turning on one or both of the LED A13 and the LED B13, in a state where the first adaptor AA and the second adaptor BB are connected by the optical transmission composite cable CC and a power source is connected to the first adaptor AA, even if a main power source switch of one or both of the first adaptor AA and the second adaptor BB is not turned on.

Further, the LAN connectors A7, B7 for operating a POE (Power over Ethernet) device are connected to the power source A10 and the power source B10, so that the POE (Power over Ethernet) device can be supplied with power.

Further, the display units A5, B5 and the external monitors D1, D2 can select and display either video signal input to the first adaptor AA or the second adaptor BB, as well as the information obtained by the determination units A2, A4, B2, B4.

### 2. Second Embodiment

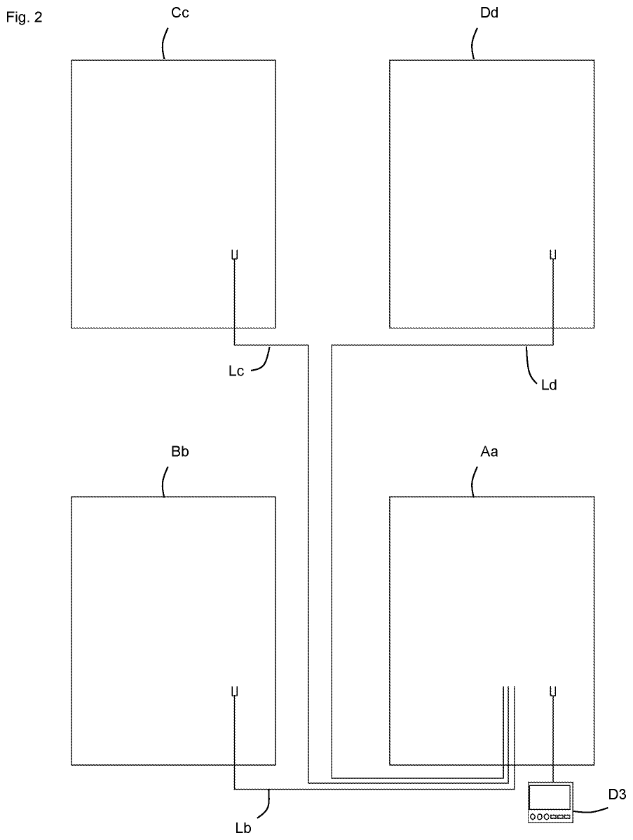

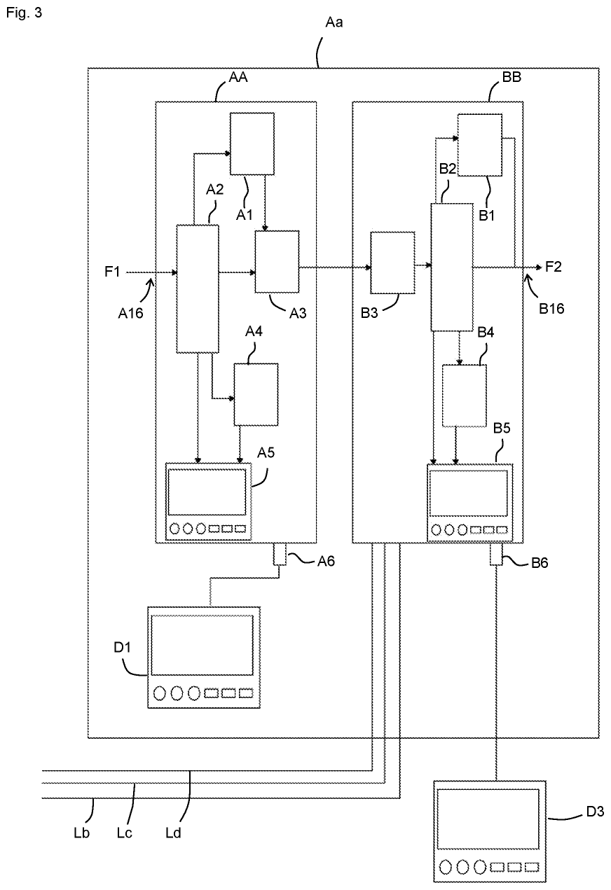

The optical transmission system of the second embodiment of the present invention is described with reference to FIG. 2 and FIG. 3. The optical transmission system of the present embodiment comprises a plurality of adaptor groups Aa, Bb, Cc, Dd. Each adaptor group comprises the first and second adaptors AA, BB. The adaptor groups Aa, Bb, Cc, Dd are connected to each other by a link cable. Specifically, the adaptor groups Bb, Cc, Dd are connected to the adaptor group Aa respectively by the link cables Lb, Lc, Ld. Although the second adaptors BB of the adaptor groups are connected to each other by the link cable in FIG. 2, the first adaptors AA may be connected to each other by the link cable. Alternatively, the first adaptor AA of one adaptor group may be connected to the second adaptor BB of the other adaptor group by the link cable.

In each adaptor group, the information about the first signal F1 is obtained by the determination units A2, A4, B2, B4, as in the first embodiment. The obtained information is sent to the adaptor group Aa via the link cable and can be collectively displayed on one external monitor D3 connected to the adaptor group Aa. Further, the information obtained from the adaptor groups Bb, Cc, Dd may be collectively transmitted to the adaptor groups Bb, Cc, Dd by the adaptor group Aa and then collectively displayed on the display units A5, B5 of the adaptor groups Aa, Bb, Cc, Dd and/or the external monitor D1.

### 3. Third Embodiment

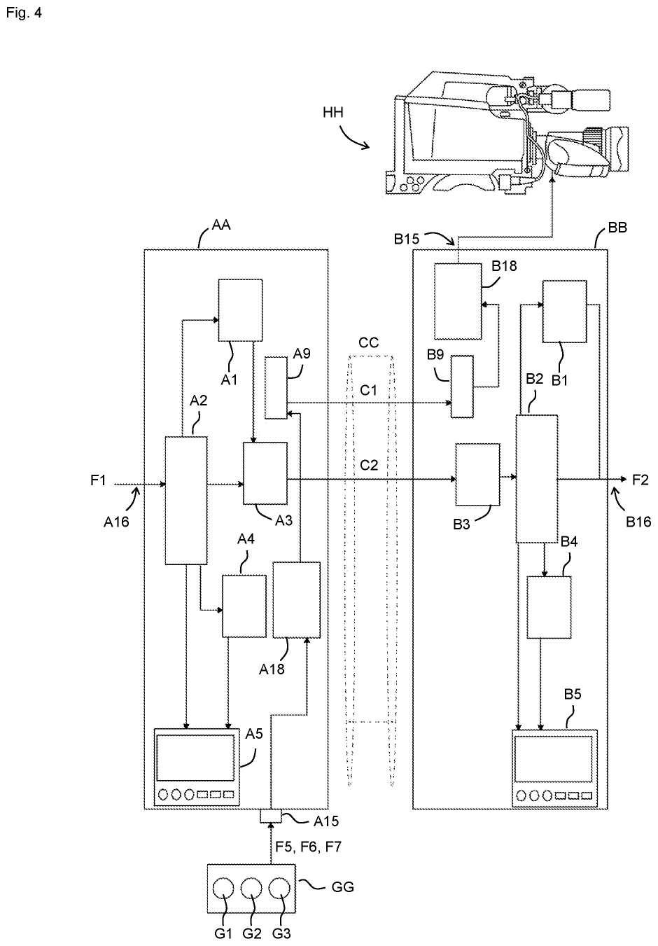

The optical transmission system of the third embodiment of the present invention is described with reference to FIG. 4. The present embodiment is similar to the first embodiment, and the main difference is that a lens of a professional-use video camera can be directly driven by a remote controller. Hereinafter, the difference is mainly described.

The first adaptor AA in the present embodiment comprises a lens-control-signal input terminal A15 and a remote controller board A18. The second adaptor BB comprises a lens-control-signal output terminal B15 and a remote controller board B18.

A remote controller GG is connected to the lens-control-signal input terminal A15. The remote controller GG is provided with an iris control G1, a focus control G2, and a zoom control G3. An iris signal F5, a focus signal F6, and a zoom signal F7 are output by operating the controls G1 to G3. The signals F5 to F7 are signals for controlling the iris, focus, and zoom of the lens, respectively. The signals F5 to F7 are sent through the remote controller board A18, the EO conversion unit A9, the cable C1, the OE conversion unit B9, and the remote controller board B18 and output from the lens-control-signal output terminal B15. The professional-use video camera HH is connected to the lens-control-signal output terminal B15, and at least one of the iris, focus, and zoom of the lens of the professional-use video camera HH can be directly driven. In this regard, the second adaptor BB may be also provided with a lens-control-signal input terminal to which a remote controller is connected, and the lens of the professional-use video camera HH may be directly driven by means of this remote controller. Further, a control panel may be provided on one or both of the first and second adaptors AA, BB, and the lens of the professional-use video camera HH may be driven by operating the control panel.

### 4. Fourth Embodiment

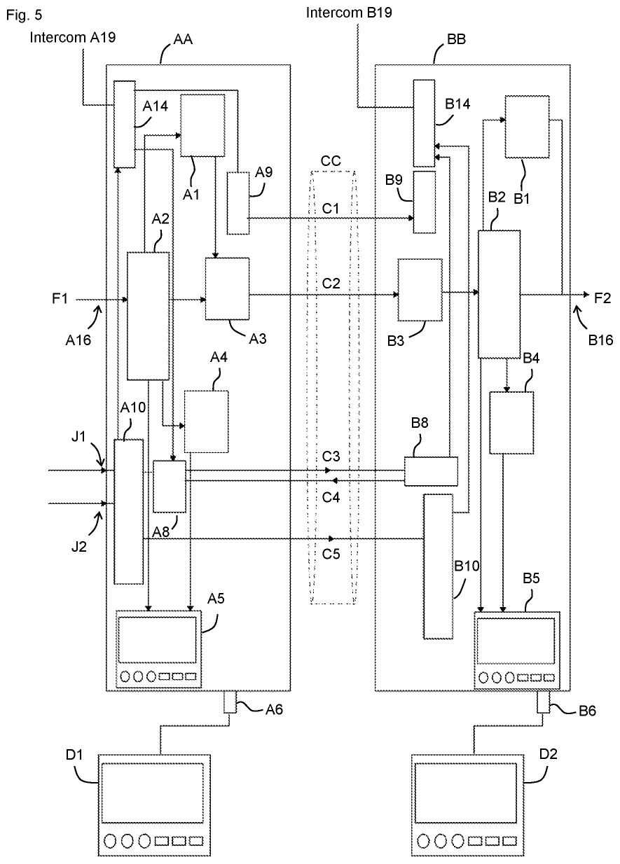

The optical transmission system of the fourth embodiment of the present invention is described with reference to FIG. 5. The present embodiment is similar to the first embodiment, and the main difference is that a function of allowing an intercom manufactured by Clear-Com to be used is provided by using an intercom circuit A14, an intercom circuit B14, and the optical transmission composite cable CC . Hereinafter, the difference is mainly described.

Intercoms A19, B19 are connected to the intercom circuits A14, B14, respectively. The intercom A19 is supplied with power from the power source A10 via the intercom circuit A14. The intercom B19 is supplied with power from the power source A10 of the first adaptor AA via the power source B10 and the intercom circuit A14.

Further, when a call button of the intercom A19 is pressed to generate a call signal by a function of the intercom manufactured by Clear-Com, the call signal is transmitted to the intercom B19 through the intercom circuit A14, the communication board A8, the cable CC, the communication board B8, and the intercom circuit B14. Similarly, when a call button of the intercom B19 is pressed, a call signal is transmitted to the intercom circuit A14.

### 5. Fifth Embodiment

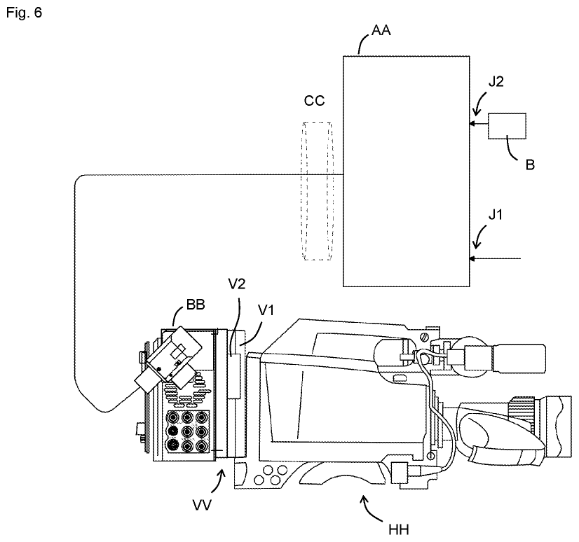

The optical transmission system of the fifth embodiment of the present invention is described with reference to FIG. 6. The present embodiment is similar to the first embodiment, and the main difference is that the second adaptor BB is equipped with a V mount VV configured to directly connect the camera HH. Hereinafter, the difference is mainly described.

The V mount VV comprises a power source V1 for driving the camera HH and a cooling fan V2 inside. The power source V1 is connected to the power source B10. The cooling fan V2 has a function of preventing temperature increase.

Power can be supplied to the first adaptor AA by connecting an AC power source to the AC input terminal J1 or by connecting a battery B to the DC input terminal J2.

While illustrative embodiments have been illustrated and described, it will be appreciated that various changes can be made therein without departing from the spirit and scope of the invention.

1. An optical transmission system for optical transmission of a signal between a first and a second adaptors,
wherein the first and the second adaptors each comprise an input terminal, a determination unit, and a display unit,
a first signal is input to the input terminal, the first signal being an analog video signal or a digital video signal,
the determination unit is configured to determine whether the first signal is the analog video signal or the digital video signal and to determine a type of the digital video signal when the first signal is the digital video signal, and
the display unit is configured to display information obtained in determination by the determination unit.

2. The optical transmission system of claim 1,
wherein the first signal is input to the input terminal of the first adaptor, and
the information is displayed on the display unit of the second adaptor.

3. The optical transmission system of claim 1,
wherein the first and the second adaptors each comprise an output connector for displaying contents of the information on an external monitor.

4. The optical transmission system of claim 1, further comprising a plurality of adaptor groups,
wherein each of the adaptor groups comprises the first and the second adaptors,
the adaptor groups are connected to each other by a link cable, and
the system is configured to collectively display the information obtained in each of the adaptor groups on an external monitor or the display unit.

5. The optical transmission system of claim 1, further comprising a function of displaying contents of the information by means of a dedicated application installed on a mobile phone.

6. The optical transmission system of claim 1,
wherein the first signal is input to the input terminal of the first adaptor, and
the second adaptor is configured to convert the first signal into a different video signal and to output the different video signal.

7. The optical transmission system of claim 1,
wherein the first signal is input to the input terminal of the first adaptor, and
the second adaptor is configured to output the first signal as it is.

8. The optical transmission system of claim 1,
wherein the first adaptor or the second adaptor comprises a lens-control-signal output terminal and is configured to directly drive at least one of iris, focus, and zoom of a lens of a professional-use video camera connected to the lens-control-signal output terminal.

9. The optical transmission system of claim 1, further comprising a control panel configured to control all or any of iris, focus, and zoom of a lens connected to the first adaptor or the second adaptor.

10. The optical transmission system of claim 1, further comprising:
an LED; and
a function of displaying a connection status by turning on the LED provided on at least one of the first adaptor and the second adaptor,
wherein the LED is configured to indicate the connection status as long as the first adaptor and the second adaptor are connected in a state where the first adaptor is connected to a driving power source and is also connected to the second adaptor by an optical composite cable, even if a main power source switch of the first adaptor and a main power source switch of the second adaptor are not turned on.

11. The optical transmission system of claim 1,
wherein the first adaptor and the second adaptor each comprise a LAN connector, and
the LAN connector is configured to supply power to a POE device connected to the LAN connector.

12. The optical transmission system of claim 1,
wherein the system is configured to select either video signal input to the first adaptor or the second adaptor and to display the video signal on an external monitor or the display unit.

13. The optical transmission system of claim 1,
wherein the first and the second adaptors each comprise a function of connecting an intercom, and
the first adaptor comprises a function of supplying power to the intercom connected to the second adaptor.

14. The optical transmission system of claim 13,
wherein the system is configured to transmit a call signal generated by pressing a call button of the intercom connected to the first adaptor, to the intercom connected to the second adaptor.

15. The optical transmission system of claim 1,
wherein the second adaptor comprises a V mount configured to directly connect the second adaptor to a camera, and
the V mount comprises a power source for driving the camera and a cooling fan inside.
